(19) United States
(12) Patent Application Publication
(10) Pub. No.: US 2022/0012687 A1
(43) Pub. Date: Jan. 13, 2022

(54) PURCHASE SYSTEMS FOR AGGREGATING CUSTOM DESIGN ITEMS AND ASSOCIATED METHODS

(71) Applicant: Givr Packaging, LLC, Melbourne, FL (US)

(72) Inventors: Jeremy Bower, Melbourne, FL (US); Brad Albright, Columbus, IN (US)

(73) Assignee: Givr Packaging, LLC, Melbourne, FL (US)

(21) Appl. No.: 17/305,544

(22) Filed: Jul. 9, 2021

Related U.S. Application Data
(60) Provisional application No. 63/050,305, filed on Jul. 10, 2020.

(51) Int. Cl. G06Q 10/08; B65B 59/00; G06T 7/00

(52) U.S. Cl. CPC G06Q 10/0875; G06Q 10/0838; G06T 2207/30242; G06T 7/0008; B65B 59/003

(57) ABSTRACT

A method for aggregating multiple independent packaging orders including receiving a plurality of packaging orders, receiving funds users for their respective packaging orders, determining an aggregate packaging order, determining an aggregate packaging order per-unit price, determining a plurality of packaging order rebates, refunding each packaging order rebate to the user associated with the packaging order associated with the packaging order rebate, and producing a plurality of packaging units.

### RELATED APPLICATIONS

This application claims priority under 35 U.S.C. § 119(e) of U.S. Provisional Patent Application Ser. No. 63/050,305 filed on Jul. 10, 2020 and titled PURCHASE SYSTEMS FOR AGGREGATING CUSTOM DESIGN ITEMS. The content of this application is incorporated herein by reference.

### FIELD OF THE INVENTION

The present invention relates to systems and methods for generating a discounted price for aggregated custom print design products.

### BACKGROUND OF THE INVENTION

Conventionally, when a customer purchases a custom box, there are a great number of upfront costs. Just setting up the press and die cutter, managing pallets, and printing the surfaces are time consuming and expensive. Conventionally for custom items, each customer bears the full cost for each order. As a result, typically, businesses offer a lower price per unit as the volume of items in the order increases.

Particularly with respect to custom digital print items, every individual print can be different within a single order. Therefore, for example, for 100 boxes, 100 different versions could be printed with the same amount of set-up costs as printing 100 boxes of the same version. For any given size of packaging, there are infinite versions that can be printed on that structure.

Conventionally, each order placed via every ecommerce packaging website is analyzed as a single order. Therefore, the orders are priced as if they each carry the price burden of the overhead associated with a single order.

In other words, there is no solution for combining multiple print versions online via ecommerce.

Accordingly, there is a need for a system to enable multiple online orders to be aggregated over a fixed period of time.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

Digital printing allows the printing of many different versions of print (i.e., different images) without adding to setup cost as long as the structure (e.g., box shape, box size) remains the same. As a result, a business can print for many clients (or different versions for a single client) with a single printing apparatus setup. For example, a rotary cutting die can be used to cut out the boxes, wherein a business can leverage a single cutting setup for many different prints. In an example, many customers (or many products) can share a single setup cost.

The present disclosure provides a system for receiving multiple purchase orders, wherein the system aggregates the orders across a set of common attributes to collectively “democratize” the machine set-ups and, thereby, the purchase price of the printed packaging. The system enables multiple people to join a “group” of purchases to leverage all of the commonalities of buying a common structure with variable print online in real time.

In an example, the system can employ an algorithm that allows for updated pricing in real time based on the total number of boxes ordered in a given time frame, across a given structure.

An advantage of the present system is solving the issue of manually grouping orders of a common size into one larger aggregate order when processing orders for custom packaging of the same size and structure via ecommerce.

A further advantage of the present system is providing cost savings by offering a “grouped” solution to short-run digital packaging buyers. For example, the customers can save on the order of 10-30% compared to the conventional linearly focused ecommerce check-out flow.

Another advantage of the present system is providing a platform to enable multiple customers to aggregate their packaging order with others buying the same size and structure into a collective buying “pool”. This allows every customer in that “pool” to democratize the associated setup and volume buying advantages available in digital printing.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for aggregating multiple independent packaging orders. The method also includes receiving a first packaging order may include a first packaging order parameter set from a first user at a purchase order interface, the first packaging order parameter set may include a first packaging order dimensioning parameter, a first packaging order volume parameter, and a first packaging order total price. The method also includes receiving funds from the first user equal to the first packaging order total price. The method also includes receiving a second packaging order may include a second packaging order parameter set from a second user at the purchase order interface, the second packaging order parameter set may include a second packaging order dimensioning parameter, a second packaging order volume parameter, and a second packaging order total price. The method also includes receiving funds from the second user equal to the second packaging order total price. The method also includes determining an aggregate packaging order may include an aggregate packaging order parameter set responsive to the first packaging order parameter set and the second packaging order parameter set, the aggregate packaging order parameter set may include an aggregate packaging order dimensioning parameter equal to the first and second packaging order dimensioning parameters and an aggregate packaging order volume parameter that is at least the sum of the first packaging order volume parameter and the second packaging order volume parameter. The method also includes determining an aggregate packaging order per-unit price responsive to the aggregate packaging order parameter set. The method also includes determining a first packaging order rebate being the difference of the first packaging order total price and the product of the aggregate packaging order per-unit price and the first packaging order volume parameter. The method also includes refunding the first packaging order rebate to the first user. The method also includes determining a second packaging order rebate being the difference of the second packaging order total price and the product of the aggregate packaging order per-unit price and the second packaging order volume parameter. The method also includes refunding the second packaging order rebate to the second user. The method also includes producing a plurality of packaging units having dimensioning equal to the aggregate packaging order dimensioning parameter and equal in number to the aggregate packaging order volume parameter, where the plurality of packaging units may include a first subset of packaging units assigned to the first packaging order and a second subset of packaging units assigned to the second packaging order. Other embodiments of this aspect include corresponding computer systems, apparatus, and computer programs recorded on one or more computer storage devices, each configured to perform the actions of the methods.

Implementations may include one or more of the following features. The method where: the first packaging order further may include a first digital image file defining a first digital image, the second packaging order further may include a second digital image file defining a second digital image, and producing the plurality of packaging units may include producing the first subset of packaging units having the first digital image printed thereon and producing the second subset of packaging units having the second digital image printed thereon. Producing the plurality of packaging units may include: operating a digital printing device to print the first digital image on a base material a number of times equal to the first packaging order volume parameter and on areas of the base material to be cut into the first subset of packaging units prior to the base material being cut; operating the digital printing device to print the second digital image on the base material a number of times equal to the second packaging order volume parameter and on areas of the base material to be cut into the second subset of packaging units prior to the base material being cut; and operating a cutting machine to cut packaging units from the base material in dimensions matching the aggregate packaging order dimensioning parameter, cutting a number of packaging units equal to the aggregate packaging order volume parameter. The cutting machine is one of a die cutting machine, a computer-aided design (CAD) cutting machine, and a laser cutting machine. Each of the first packaging order and second packaging order are received within the aggregation time period, and where packaging orders received outside the aggregation time period will be aggregated into a second aggregated order. The first packaging order parameter set further may include an aggregation per-unit price threshold level parameter, and packaging units for the first packaging order are not produced until the aggregate packaging order per-unit price is equal to or below the aggregation per-unit price threshold level parameter. The aggregate order parameter set further may include a minimum order volume, each of the first packaging order volume parameter and second packaging order volume parameter are compared to the minimum order volume, and a packaging order may include an order volume parameter not greater than or equal to the minimum order volume is not included in the aggregate order. The aggregate packaging order per-unit price is determined further responsive to at least one of historical aggregated orders prices, historical purchase order prices for one of the first user and the second user, and competitor order prices. The aggregate packaging order per-unit price is determined further responsive to a gross margin above a known aggregate cost for producing a quantity of packaging units equal to the aggregate packaging order volume parameter in a size equal to the aggregate packaging order dimensioning parameter. Implementations of the described techniques may include hardware, a method or process, or computer software on a computer-accessible medium.

One general aspect includes a system for aggregating multiple independent packaging orders. The system also includes a server may include a non-transitory a computer-readable medium may include software for operating a website configured to: receive a first packaging order may include a first packaging order parameter set from a first user at a purchase order interface, the first packaging order parameter set may include a first packaging order dimensioning parameter, a first packaging order volume parameter, a first packaging order total price, and a first digital image file defining a first digital image; receive funds from the first user equal to the first packaging order total price; receive a second packaging order may include a second packaging order parameter set from a second user at the purchase order interface, the second packaging order parameter set may include a second packaging order dimensioning parameter equal to the first packaging order dimensioning parameter, a second packaging order volume parameter, a second packaging order total price, and a second digital image file defining a second digital image; and receive funds from the second user equal to the second packaging order total price; determine an aggregate packaging order may include an aggregate packaging order parameter set responsive to the first packaging order parameter set and the second packaging order parameter set, the aggregate packaging order parameter set may include an aggregate packaging order dimensioning parameter equal to the first and second packaging order dimensioning parameters and an aggregate packaging order volume parameter that is equal to the sum of the first packaging order volume parameter and the second packaging order volume parameter; determine an aggregate packaging order per-unit price responsive to the aggregate packaging order parameter set; determine a first packaging order rebate being the difference of the first packaging order total price and the product of the aggregate packaging order per-unit price and the first packaging order volume parameter; and determine a second packaging order rebate being the difference of the second packaging order total price and the product of the aggregate packaging order per-unit price and the second packaging order volume parameter. The system also includes where the website is further configured to: refund the first packaging order rebate to the first user, and refund the second packaging order rebate to the second user. The system also includes a digital printing device positioned in communication with the server and configured to: print the first digital image on a base material a number of times equal to the first packaging order volume parameter and on areas of the base material to be cut into a first subset of packaging units assigned to the first packaging order, and print the second digital image on the base material a number of times equal to the second packaging order volume parameter and on areas of the base material to be cut into a second subset of packaging units assigned to the second packaging order. The system also includes a cutting machine positioned in communication with the server and configured to: cut the first subset of packaging units from the base material in dimensions matching the aggregate packaging order dimensioning parameter in the areas of base material having the first digital image printed thereupon, and cut the second subset of packaging units from the base material in dimensions matching the aggregate packaging order dimensioning parameter in the areas of base material having the second digital image printed thereupon. Other embodiments of this aspect include corresponding computer systems, apparatus, and computer programs recorded on one or more computer storage devices, each configured to perform the actions of the methods.

Implementations may include one or more of the following features. The system where the cutting machine is one of a die cutting machine, a computer-aided design (CAD) cutting machine, and a laser cutting machine. The software for operating a website is further configured to define an aggregation time period during which received orders having the same dimensioning will be aggregated, and each of the first packaging order and second packaging order are received within the aggregation time period, and where orders received outside the aggregation time period will be aggregated into a second aggregated order. the first packaging order parameter set further may include an aggregation per-unit price threshold level parameter, and packaging units for the first packaging order are not produced until the aggregate packaging order per-unit price is equal to or below the aggregation per-unit price threshold level parameter. the aggregate order parameter set further may include a minimum order volume, each of the first packaging order volume parameter and second packaging order volume parameter are compared to the minimum volume order, and an order may include an order volume parameter not greater than or equal to the minimum order volume are not included in the aggregate order. The software is further configured to determine the aggregate packaging order per-unit price responsive to at least one of historical aggregated orders prices, historical purchase order prices for one of the first user and the second user, and competitor order prices. The software is further configured to determine the aggregate packaging order per-unit price responsive to a gross margin above a known aggregate cost for producing a quantity of packaging units equal to the aggregate packaging order volume parameter in a size equal to the aggregate packaging order dimensioning parameter. Implementations of the described techniques may include hardware, a method or process, or computer software on a computer-accessible medium.

One general aspect includes a method for aggregating multiple independent packaging orders. The method also includes receiving a plurality of packaging orders each may include a packaging order parameter set from a plurality of users at a purchase order interface, each packaging order parameter set of the plurality of orders may include a packaging order dimensioning parameter, a packaging order volume parameter, and a packaging order total price. The method also includes receiving funds each user of the plurality of users equal to the packaging order total price for their respective packaging orders. The method also includes determining an aggregate packaging order may include an aggregate packaging order parameter set responsive to the packaging order parameter sets of the plurality of packaging orders, the aggregate packaging order parameter set may include an aggregate packaging order dimensioning parameter equal to the packaging order dimensioning parameters of the plurality of packaging orders and an aggregate packaging order volume parameter that is at least the sum of the packaging order volume parameters of the plurality of packaging orders. The method also includes determining an aggregate packaging order per-unit price responsive to the aggregate packaging order parameter set. The method also includes determining a plurality of packaging order rebates, each packaging order rebate being associated with an order of the plurality of packaging orders, being the difference of the packaging order total price for each packaging order of the plurality of packaging orders and the product of the aggregate packaging order per-unit price and the packaging order volume parameter for each packaging order. The method also includes refunding each packaging order rebate to the user associated with the packaging order associated with the packaging order rebate. The method also includes producing a plurality of packaging units having dimensioning equal to the aggregate packaging order dimensioning parameter and equal in number to the aggregate packaging order volume parameter, where the plurality of packaging units may include a subset of packaging units assigned to each packaging order of the plurality of packaging orders. Other embodiments of this aspect include corresponding computer systems, apparatus, and computer programs recorded on one or more computer storage devices, each configured to perform the actions of the methods.

Implementations may include one or more of the following features. The method where: the packaging orders of the plurality of packaging orders further may include digital image files may include respective digital images; and producing the plurality of packaging units may include: operating a digital printing device to print the digital images on a base material a number of times equal to the packaging order volume parameter for the packaging order associated with each digital image and on areas of the base material to be cut into a subset of packaging units prior to the base material being cut; and operating a cutting machine to cut packaging units from the base material in dimensions matching the aggregate packaging order dimensioning parameter, cutting a number of packaging units equal to the aggregate packaging order volume parameter. The cutting machine is one of a die cutting machine, a computer-aided design (CAD) cutting machine, and a laser cutting machine. At least one of the packaging order parameter sets of the plurality of packaging order parameter sets further may include an aggregation per-unit price threshold level parameter, and packaging units are not produced until the aggregate packaging order per-unit price is equal to or below the aggregation per-unit price threshold level parameter. Implementations of the described techniques may include hardware, a method or process, or computer software on a computer-accessible medium.

Additional objects, advantages and novel features of the examples will be set forth in part in the description which follows, and in part will become apparent to those skilled in the art upon examination of the following description and the drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

Some embodiments of the present invention are illustrated as an example and are not limited by the figures of the accompanying drawings, in which like references may indicate similar elements.

The drawing figures depict one or more implementations in accord with the present concepts, by way of example only, not by way of limitations. In the figures, like reference numerals refer to the same or similar elements.

FIG. 1 is a schematic of an example of a user interface display allowing user input on size selection and calendar information.

FIG. 2 is an example of a user interface displaying the user selection of a 9″×6″×3″ size selection and quantity selection.

FIG. 3 is an example of a user interface displaying a document upload prompt for user images.

FIG. 4 is an example of a user interface displaying a document upload prompt for user images for both the outside die line template and the inside die line template.

FIGS. 5A-5B are examples of the outside die line template and the inside die line template.

FIGS. 6A-6B are examples of a purchase order confirmation.

FIG. 7 is a chart illustrating a plurality of purchase orders.

FIG. 8 is an example of a back-end interface that illustrates the plurality of purchase orders for the system.

FIG. 9 is a graphic illustrating the unit cost verses the aggregate buying options illustrating discount pricing for aggregated orders.

FIG. 10 is a graphic illustrating the unit cost verses the aggregate buying options illustrating as the multiple orders are accumulated, the business cost decrease, while the customer's rebate increases.

FIG. 11 is a flowchart illustrating a method according to an embodiment of the invention.

FIG. 12 is a flowchart illustrating a method of producing packaging pursuant to the method of FIG. 11.

FIG. 13 is a schematic view of a system operable to perform the method depicted in FIGS. 11-12.

FIG. 14 is a flowchart illustrating a method according to an embodiment of the invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

The present system can receive multiple purchase orders, wherein the system selects individual orders for creating an aggregate orders, wherein the orders are aggregated across a set of common attributes to collectively share the machine set-up and packaging cost and, thereby, the purchase price of the printed packaging. Although the present description is directed to an example of printed boxes, it is contemplated that the system can be used with any number of purchased items.

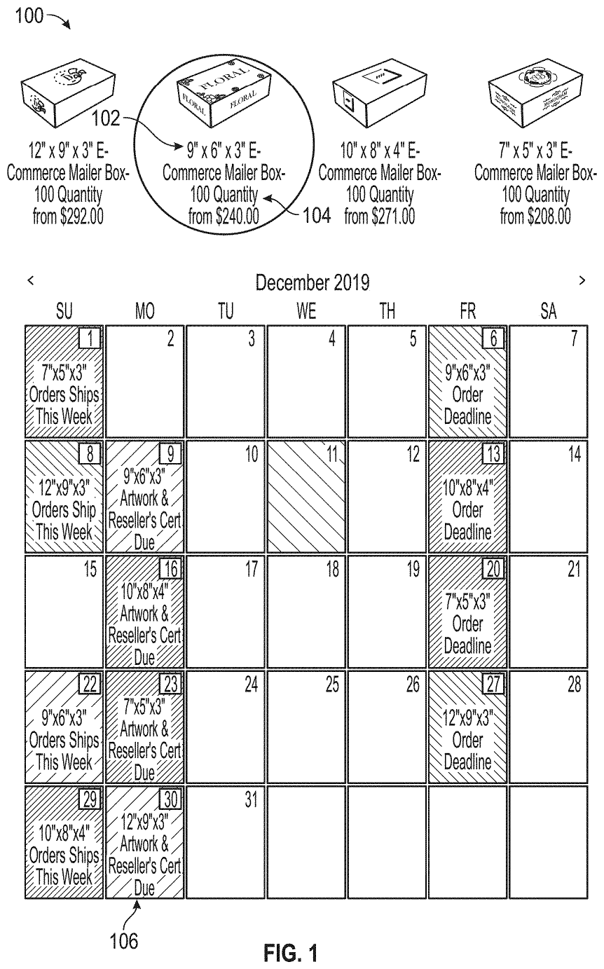

As shown in FIG. 1, the system can include a purchase order interface 100 for receiving user input of a purchase order. The purchase order can include a size of the item 102, the amount of the item 104, and the requested date for delivery 106. In an example, the system may include a calendar 106 that displays to receive user input to identify the date at which the user needs the items delivered.

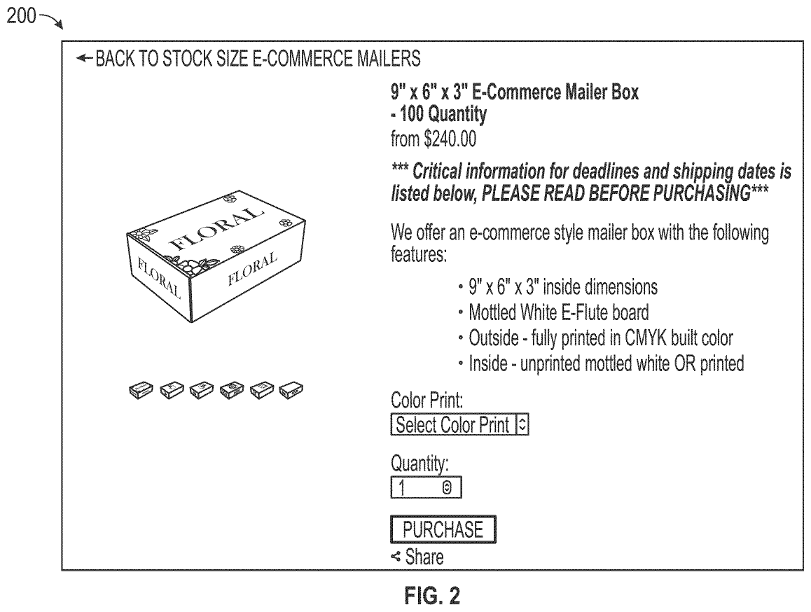

FIG. 2 is an example of the user interface 200 of the size selection of 9″×6″×3″. In the example, the price of the selection is per 100 units. The initial price of the unit can correspond to a non-aggregated, and, therefore, a non-discounted price. The aggregated price can be predetermined for a greater number of units. For example, the aggregated price can be associated with 200-500 units.

For example, the non-aggregated price can be $4.04 per box or $404.00 per 100 boxes. The cost can be determined based on demand for a given size and estimate of the probability that the business will receive greater than 300 unit orders. For example, the cost for 100 boxes with aggregation could $3.801 per box or $380.10 per 100 boxes.

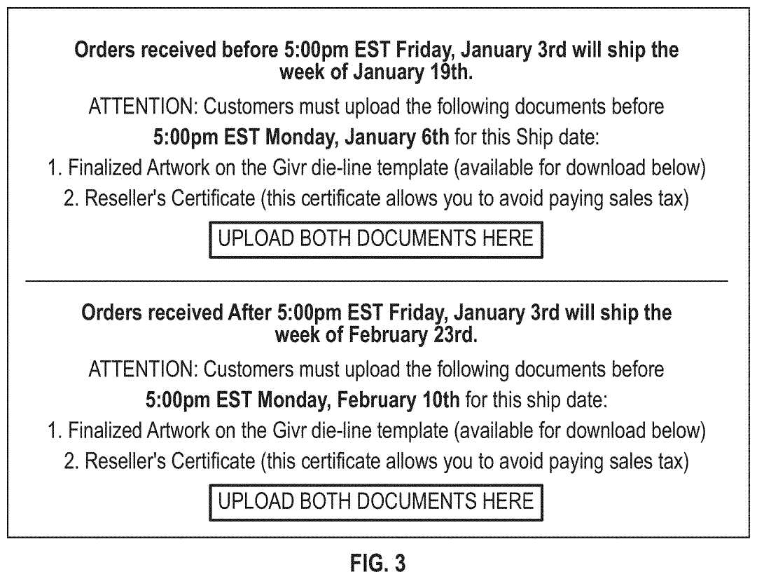

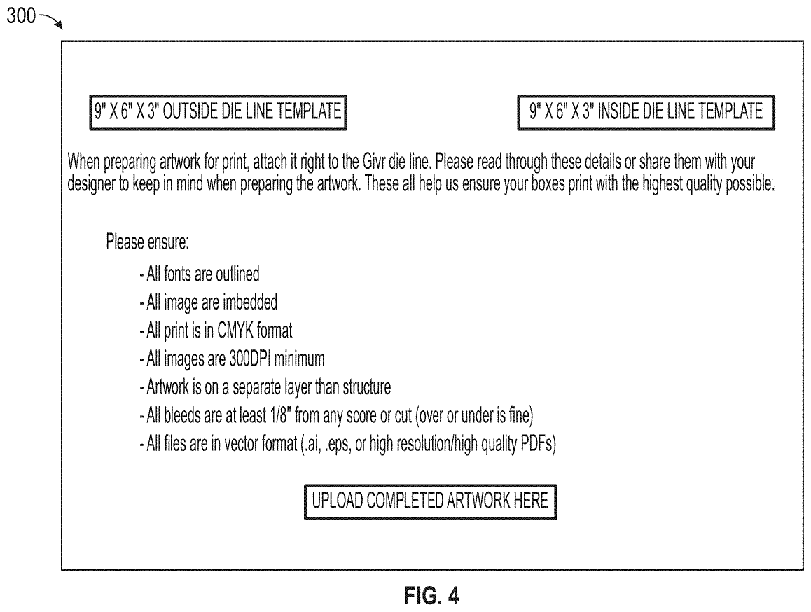

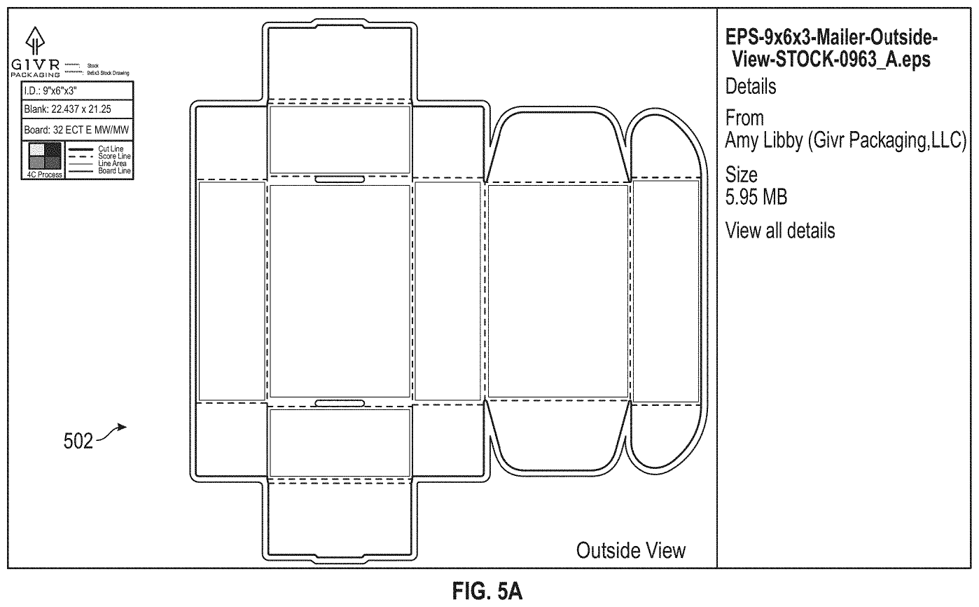

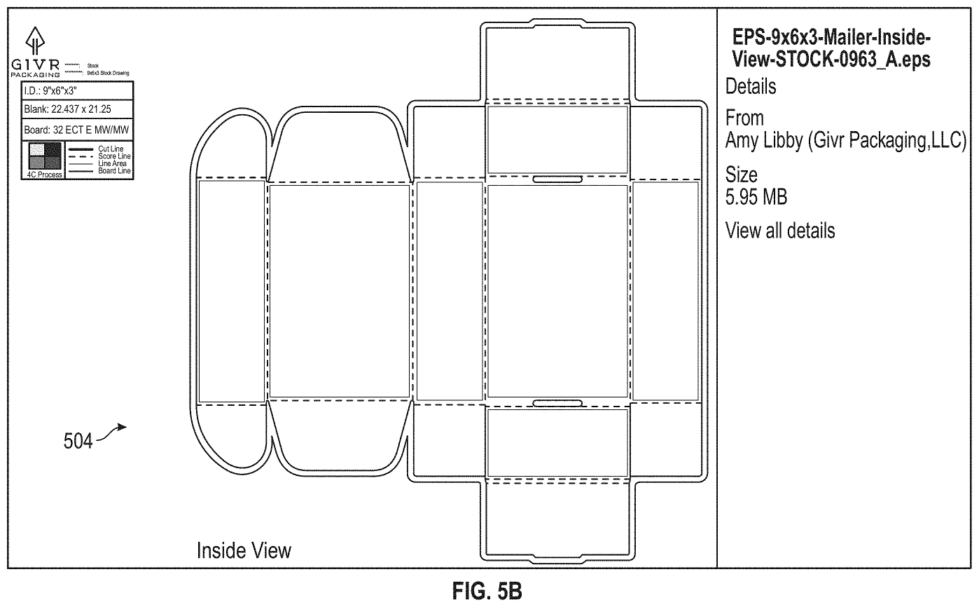

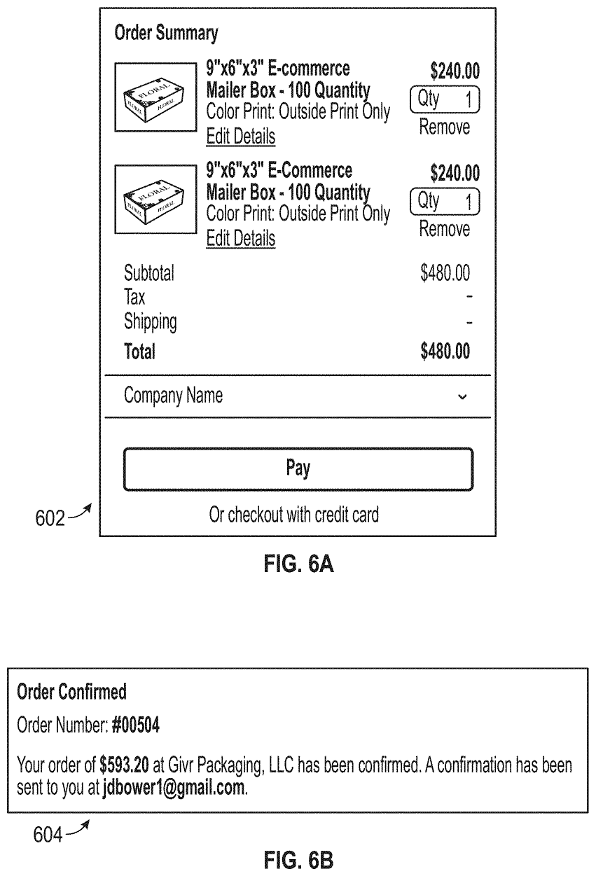

The system can receive files from a user that can be used by the system for printing on the surface of the selected item. FIGS. 3-4 illustrate an example of a user interface 300 wherein the user can upload files. The files can be image files, audio, visual, video, text, among others. In an example, the system displays the date before which the user must upload the images for the order to be met by the delivery date specified. Separate image files can be uploaded for the inside template and the outside template (i.e., different art work can be printed on the inside and outside of the box). FIGS. 5A-5B illustrates the inside 502 and outside 504 box templates for receiving the print material. An example of a check out interface 602 and order confirmation 604 is shown in FIGS. 6A-6B.

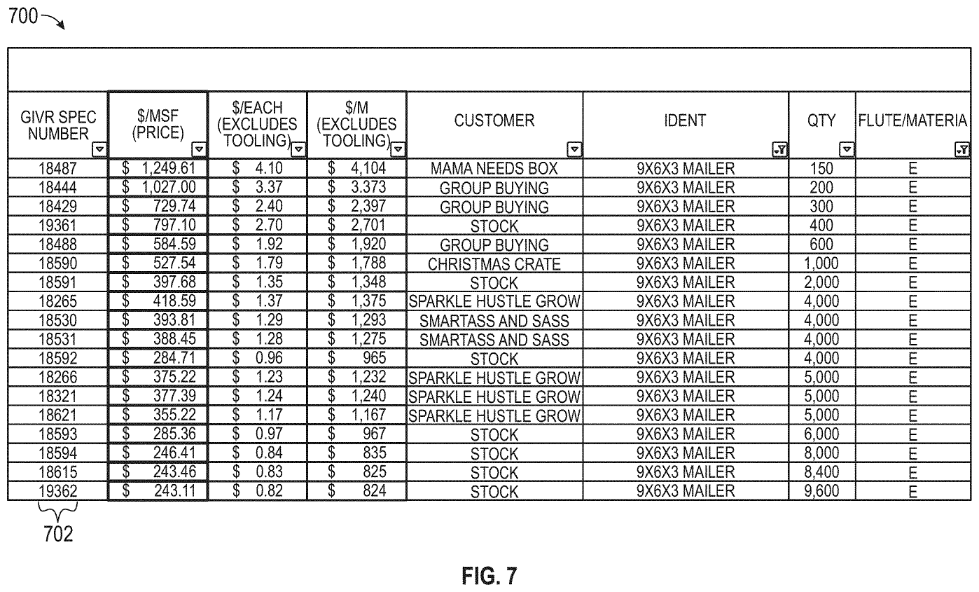

FIG. 7 is an example of a spreadsheet 700 of purchase orders received by the system. The system may use the spreadsheet 700 to aggregate orders 702 in order to reduce costs to the business and customers. The system can determine the shipping costs that can be taken into account for the price quote to the customer. The system can provide a shipping label to the supplier with the purchase order.

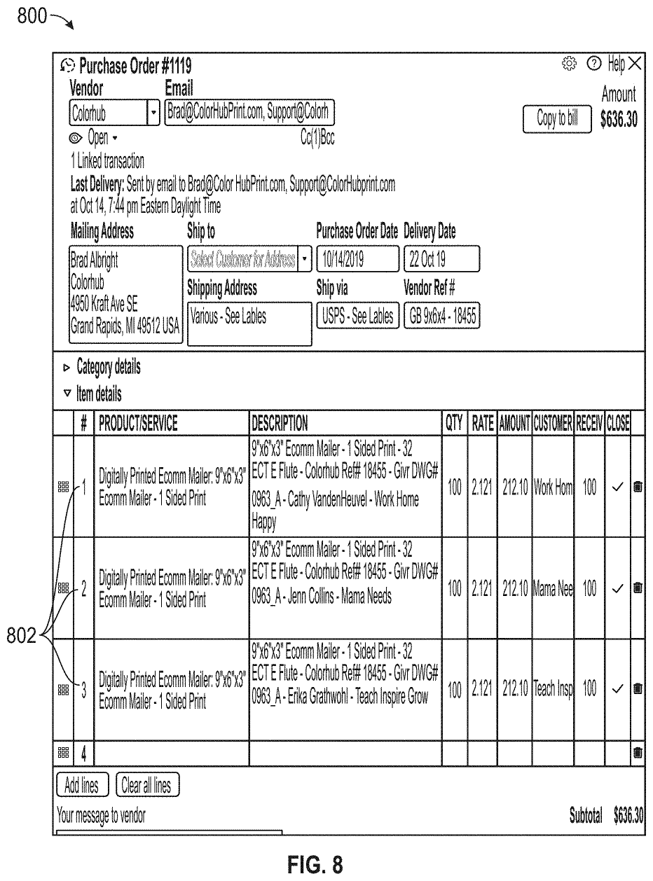

FIG. 8 is an example of the input purchase orders 800. The system can enable manual aggregation of multiple orders 802 and/or automatic aggregation of multiple orders 802. The system can include an option that allows the system and/or customer to set a predetermined threshold price under which the system automatically places the order (or aggregation of orders) into production.

The system can generate and provide a discount to the customer at the time of purchase and/or in the form of a rebate after the order. For example, for generating an upfront discount, the system can aggregate orders to at least a volume of 300 units, with a minimum order of 100 per customer. Alternatively, or in addition to, the system can have the user place the order and then provide a rebate based on the actual aggregated cost. The system can determine the discount and/or rebate based on historical cost data, historical purchase data, user profile information, business profile information, among others.

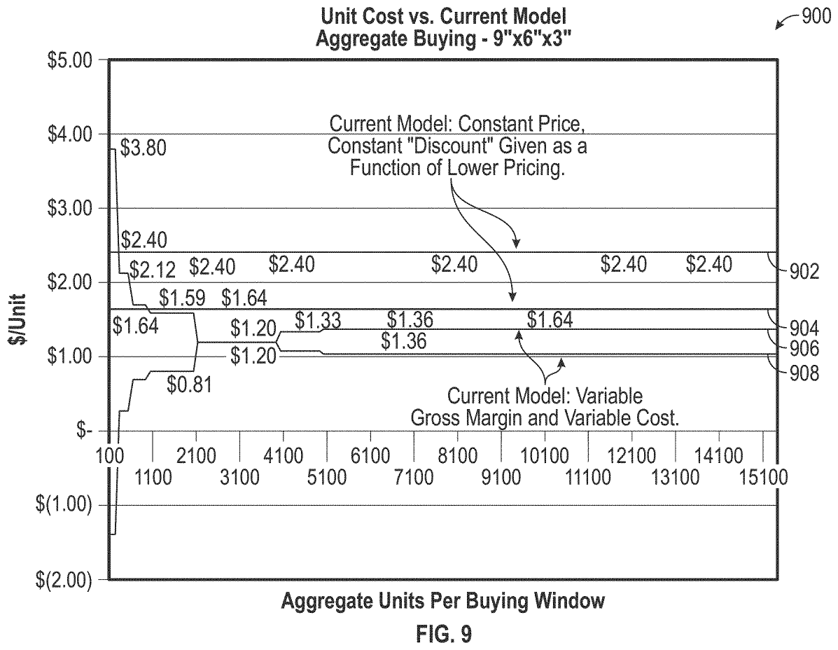

FIG. 9 illustrates a non-dynamic model 900 generated by the system wherein a first line 902 is an aggregate price provided to the customer, a second line 904 is what the customer saves buying from the business versus buying from a next lowest priced competitor, a third line 906 is the business's margin per box, and a fourth line 908 is the business's cost.

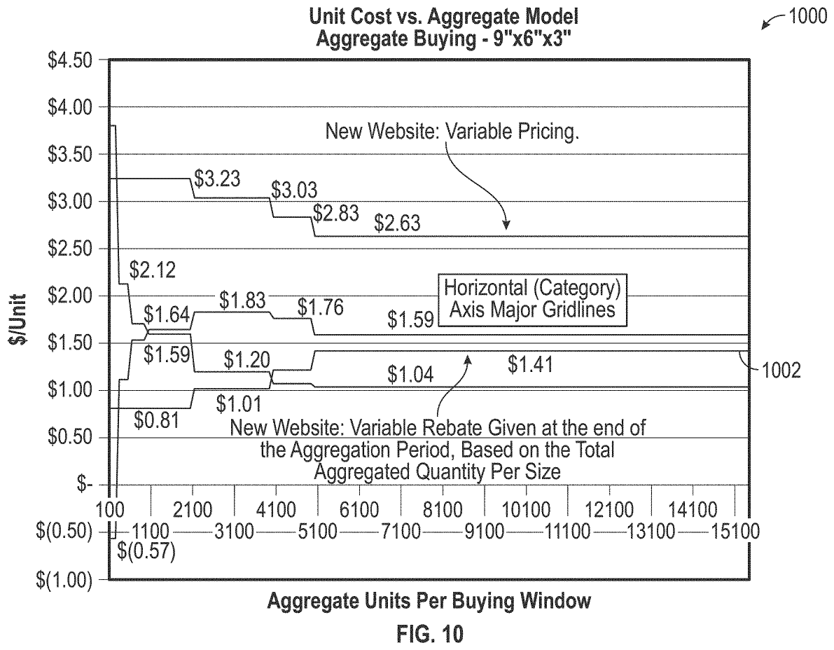

FIG. 10 illustrates a Dynamic Rebate Model 1000 generated by the system wherein a customer can purchase and check out at the initial price associated with the customer purchase order, wherein the price is directly related to the order quantity. The system can subsequently generate a rebate amount 1002 once a threshold of orders has accumulated to enable a discount for the customer purchase order. The system can then provide the rebate to the customer once the amount of orders has accumulated to allow for the discount. For example, as the system accumulates multiple orders, the costs decrease relative to the price, and the rebate increases as a percentage of the purchase order amount. The system can take into account historical aggregated order price, historical purchase order price for the specific customer, competitor prices when determining the rebate amount.

In an example, the system can determine the rebate price based at least part on a competitor price. For example, the system can access a historical and/or real time price of at least one competitor for the same or similar order.

For example, for a 9″×6″×3″ box order, the system may determine that for 100 quantity a competition charges on average $4.04/box. The system can use the competitor price as a market price for 100 quantity. The system determines the estimated price should be lower than $4.04/box in order to provide a costs savings, and thereby a rebate to the customer.

For example, in the system, 100 boxes may cost higher than the competitor's selling price. For example, the system may have a cost is $5.04/box. However, when the system aggregates orders such that the buying quantity is 300 or greater, the system can determine the cost for 300 to be $2.12/box for each box of that order. Then the system can assume that the system will acquire at least 300 boxes worth of orders and the system will base the price to the customer on the assumption. With the assumption, the system will have some gross margin to provide a savings to the customer, and also leftover margin to contribute to the system's bottom line. The system can then decide to set the price at 20% lower than the competitor's market rate. Although, the percentage is not limited to 20%, and instead the percentage is subjective and can vary by the size and quantity of the order. An objective of the system is to make a large enough percentage or real-dollar discount on the price where customers cannot ignore the savings and wherein the rebate becomes a real, tangible amount that corresponds to significant savings. In the example, the customer's perceived rebate can be 20%, which makes the system's sell price of $3.23/box, which creates a per-box rebate of $0.81/box, or $81 per every order of 100 boxes.

In an example, the Market Price can be the price determined based on market research of some or all known competitor's prices for a given box size and quantity.

In an example, the Aggregate Price can be the price established based on an assumed aggregate quantity and assumed aggregate cost, to include some discount off of market price, and some gross margin above a known aggregate cost.

In an example, the Aggregate Cost can be the pre-negotiated cost the system will pay for a given quantity of boxes. This aggregate cost can be less than, equal to, or greater than the order quantity of a specific customer.

In an example, the Rebate can be some percentage of the delta between the market price and the aggregate cost.

In an example, instead of accepting a rebate credit and instead of applying the rebate as cash to a customer's account, the system can convert the rebate amount into an equivalent number of additional items. For example, if the price drops 60 dollars on an order between when the order was placed and when the order is fulfilled, the system can present an option that coverts the 60 dollars into an equivalent worth of additional items (e.g., boxes) at the fulfillment price. The system can enable customers to convert their rebates into products at a time when the customer knows the rebate will obtain a greater value per dollar.

In an example, the system can adjust the price based the customer agreement of incorporating a selected advertisement into their order. For example, the user can agree to incorporating a selected advertisement on the printed item (e.g., box). The acceptance of the advertisement can be used in exchange for lower cost to the customer for the purchase price.

In an example, the system can provide a checkout option in which the system automatically sizes the customer's package options based on the customer's inputs. Rather than a customer selecting a box size, the customer may simply input options and the system can optimize the order by analyzing what other orders can be matched to create the largest aggregated order discount. Examples of input options include, but not limited to, size/unit, weight/unit, case counts, material (glass, plastic, etc.), orientation (e.g., do the contents have to remain upright), temperature constraints, whether internal packaging is required, etc. In addition, or alternatively, the system can automatically select a size selection based on the user's uploaded image files.

In an example, the system can provide automated box ordering that correlates to a customer's sales. For example, the system can include an API that is used with a customer's sales software (e.g., Shopify, Magento, etc.), wherein the system can automatically place a purchase order of the correct size and quantity of boxes based on the sales of the customer. In an example, the system can include software that only completes the order when the aggregated price drops below a preset threshold.

In an example, in response to a customer uploading images (e.g., art, logos, etc.), the system can automatically convert the image file into various options and provide the options to the customer such that the customer can select the option/price. The system can provide the multiple options at the point sale. For example, the system can receive a four color image file and, in response, the system can provide an option for printing in full color. However, the system can also provide a second option for printing three colors and substituting gray scale for the fourth. The system can provide an option for printing in black and white, wherein the system presents via a user interface the impact of the color on the cost, wherein the customer can select the desired option. For example, there might be options for 1-10 colors.

The system can print shipping information on each individual box, such that the boxes are labeled before the orders are filled. Conventionally the shipping information comes after the packing stage, which is another step of printing labels and applying them. Therefore, the present system provides a more efficient method for applying printing labels.

In an example, the system can include a calculation of the number of trees affected by the order, rounding up to a whole number, multiplying by 20, planting that many trees.

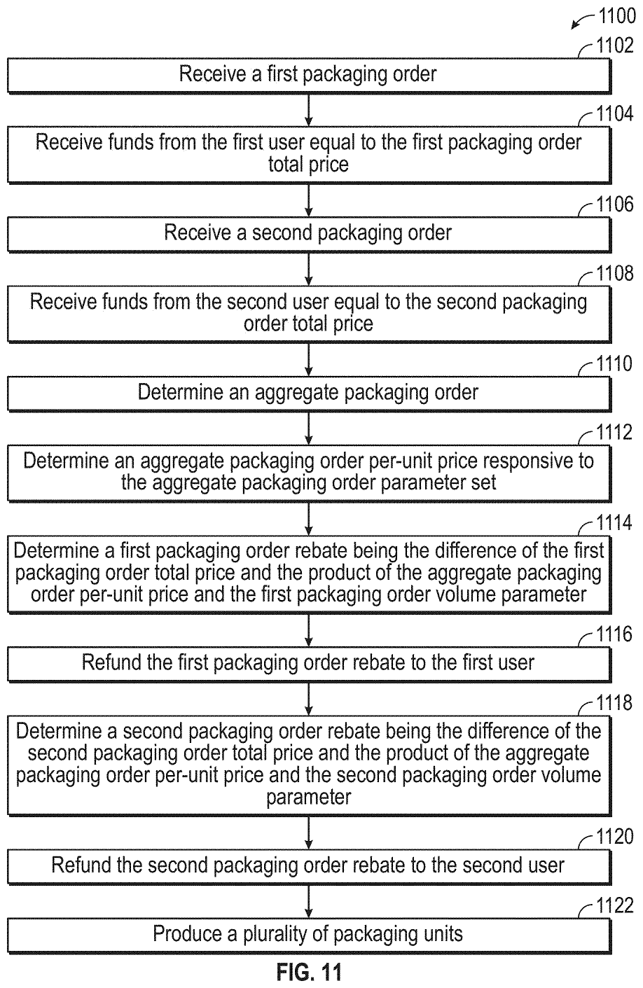

Referring now to FIG. 11, a method 1100 according to an embodiment of the invention is presented. The method 1100 may comprise receiving a first packaging order at step 1102. The first packaging order may be placed using the user interface described above, which may be a website run on a server comprising software stored on a non-transitory storage medium to operate the website and accessed by the user using a user computerized device across a network, such as the Internet. The first packaging order may be received at the server. The first packaging order may comprise a first packaging order parameter set from a first user at a purchase order interface on the website, the first packaging order parameter set comprising a first packaging order dimensioning parameter, a first packaging order volume parameter, and a first packaging order total price. The first packaging order dimensioning parameter may be the dimensions of the packaging desired by the user. The first packaging order volume parameter may be the quantity of packaging units the user is ordering. The first packaging order total price may be agreed to by the user after having been provided by the purchase order interface with the non-aggregated price as described hereinabove. The method 1100 may continue with received funds from the first user equal to the first packaging order total price at step 1104. Such a fund transfer may be accomplished by any means or method as is known in the art, including, but not limited to, a credit card transaction, a bank transfer or Automated Clearing House (ACH) transaction, a transaction with an intermediary service such as PayPal, Amazon Pay, and the like, a wire transfer, and the like.

The method 1100 may continue at step 1106 with receiving a second packaging order comprising a second packaging order parameter set from a second user at the purchase order interface, the second packaging order parameter set comprising a second packaging order dimensioning parameter, a second packaging order volume parameter, and a second packaging order total price. The second packaging order price may similarly be agreed to by the user after having been provided by the purchase order interface with the non-aggregated price as described hereinabove. In some embodiments, the second packaging order dimensioning parameter may be equal to the first packaging order dimensioning parameter, and in some embodiments they may be different. The method 1100 may continue at step 1108 with receiving funds from the second user equal to the second packaging order total price.

The method 1100 may continue at step 1110 with determining an aggregate packaging order. Determining an aggregate packaging order may comprise determining an aggregate packaging order parameter set responsive to the first packaging order parameter set and the second packaging order parameter set. The aggregate packaging order parameter set may comprise an aggregate packaging order dimensioning parameter and an aggregate packaging order volume parameter that is at least the sum of the first packaging order volume parameter and the second packaging order volume parameter. Where the first and second packaging order dimensioning parameters are equivalent, the aggregate packaging order dimensioning parameter may be equal to the first and second packaging order dimensioning parameters. Where the first and second packaging order dimensioning parameters are different, the aggregate packaging order dimensioning parameter may include each of the first and second packaging order dimensioning parameters.

The method 1100 may continue at step 1112 with determining an aggregate packaging order per-unit price responsive to the aggregate packaging order parameter set. The aggregate packaging order per-unit price may be determined using any of the aggregate pricing methodologies described hereinabove. For example, the aggregate packaging order per-unit price may be determined further responsive to a gross margin above a known aggregate cost for producing a quantity of packaging units equal to the aggregate packaging order volume parameter having dimensions equal to the aggregate packaging order dimensioning parameter. As another example, wherein the aggregate packaging order per-unit price may be determined further responsive to at least one of historical aggregated orders prices, historical purchase order prices for one of the first user and the second user, and competitor order prices. The method 1100 may continue at step 1114 with determining a first packaging order rebate being the difference of the first packaging order total price and the product of the aggregate packaging order per-unit price and the first packaging order volume parameter and at step 1116 with refunding the first packaging order rebate to the first user. The first packaging order rebate may be refunded to the first user by any transactions means or method as described hereinabove or provided to the first user as a credit for use in a future transaction on the purchase order interface.

Similarly, the method 1100 may continue at step 1118 with determining a second packaging order rebate being the difference of the second packaging order total price and the product of the aggregate packaging order per-unit price and the second packaging order volume parameter and at step 1120 with refunding the second packaging order rebate to the second user.

The method 1100 may conclude at step 1122 with producing a plurality of packaging units having dimensioning equal to the aggregate packaging order dimensioning parameter and equal in number to the aggregate packaging order volume parameter. The plurality of packaging units may comprise a first subset of packaging units assigned to the first packaging order and a second subset of packaging units assigned to the second packaging order. Where the first and second first and second packaging order dimensioning parameters are different, the first and second subsets of packaging units may be differentiated by size.

In some embodiments, the aggregate order parameter set may further comprise a minimum order volume. Each of the first packaging order volume parameter and second packaging order volume parameter may be compared to the minimum order volume to ensure they are above the minimum order volume. Any packaging order comprising an order volume parameter not greater than or equal to the minimum order volume is not included in the aggregate order.

In some embodiments, the first packaging order parameter set may further comprise an aggregation per-unit price threshold level parameter, defining a threshold that the aggregation per-unit price must meet or be below. Packaging units for the first packaging order may not be produced until the aggregate packaging order per-unit price is equal to or below the aggregation per-unit price threshold level parameter.

In some embodiments, an aggregation time period may be defined during which received orders will be aggregated. In some embodiments, packaging orders having the save dimensioning may be aggregated. In some embodiments, each of the first packaging order and second packaging order are received within the aggregation time period. Orders received outside the aggregation time period will be aggregated into a second aggregated order.

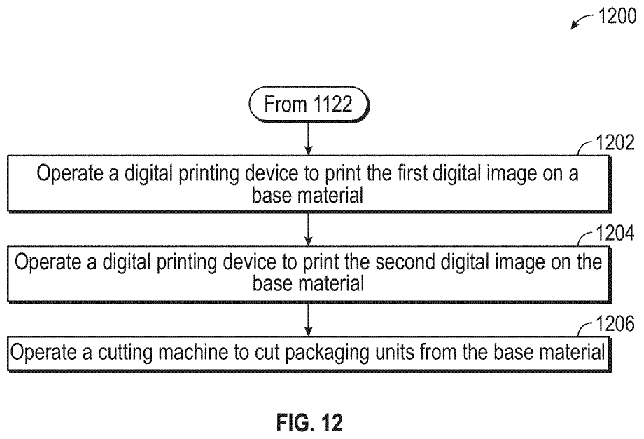

Referring now to FIG. 12, a method 1200 of producing a plurality of packaging units is presented. In embodiments that practice the method 1200, the first packaging order may comprise a first digital image file comprising a first digital image, such image being uploaded by the first user as described hereinabove, and the second packaging order may comprise a second digital image file comprising a second digital image. The method 1200 may continue from step 1122 of FIG. 11 and comprise operating a digital printing device to print the first digital image on a base material at step 1202. The base material may be material that can later be cut, scored, bent, folded, and otherwise manipulated to construct packaging units for the first packaging order. The digital printing device may be any type of digital printing device as is known in the art, including, but not limited to, digital presses, inkjet printers, digital cylinder printing, and the like. The digital printing device may print the first digital image on the base material a number of times equal to the first packaging order volume parameter. Moreover, such printing may be done on areas of the base material to be cut into the first subset of packaging units prior to the base material being cut. More specifically, the first digital image may be printed on areas of the base material such that, when the base material is cut, the first digital image will be in a desired location (e.g. top of box, outer side of box, outer bottom of box, inside of box, etc.) when the base material is cut and formed into the packaging unit. Where the first packaging order includes multiple images, those images may be printed in the appropriate areas of the base material to similarly be in the appropriate location when the packaging unit is formed.

The method 1200 may continue at step 1204 with operating the digital printing device to print the second digital image on the base material a number of times equal to the second packaging order volume parameter and on areas of the base material to be cut into the second subset of packaging units prior to the base material being cut, similar to the printing of the first digital image.

The method 1200 may continue at step 1206 with operating a cutting machine to cut packaging units from the base material in dimensions matching the aggregate packaging order dimensioning parameter, cutting a number of packaging units equal to the aggregate packaging order volume parameter. The cutting machine may be any cutting machine as is known in the art, including, but not limited to, die cutting machines, computer-aided design (CAD) cutting machines, and laser cutting machines. The cutting machine may cut the base material in areas responsive to the printing of the first and second digital images. Specifically, the cutting machine may cut areas of the base material to form a packaging unit of appropriate dimensioning and appropriate placement of the respective digital images such that the cut base material may be formed into the first and second subsets of packaging units.

As mentioned above, aspects of the systems and methods described herein are controlled by one or more controllers. The one or more controllers may be adapted to run a variety of application programs, access and store data, including accessing and storing data in the associated databases, and enable one or more interactions as described herein. Typically, the controller is implemented by one or more programmable data processing devices. The hardware elements, operating systems, and programming languages of such devices are conventional in nature, and it is presumed that those skilled in the art are adequately familiar therewith.

For example, the one or more controllers may be a PC based implementation of a central control processing system utilizing a central processing unit (CPU), memory and an interconnect bus. The CPU may contain a single microprocessor, or it may contain a plurality of microprocessors for configuring the CPU as a multi-processor system. The memory may include a main memory, such as a dynamic random access memory (DRAM) and cache, as well as a read only memory, such as a PROM, EPROM, FLASH-EPROM, or the like. The system may also include any form of volatile or non-volatile memory. In operation, the memory stores at least portions of instructions for execution by the CPU and data for processing in accord with the executed instructions.

The one or more controllers may also include one or more input/output interfaces for communications with one or more processing systems. Although not shown, one or more such interfaces may enable communications via a network, e.g., to enable sending and receiving instructions electronically. The communication links may be wired or wireless.

The one or more controllers may further include appropriate input/output ports for interconnection with one or more output mechanisms (e.g., monitors, printers, touchscreens, motion-sensing input devices, etc.) and one or more input mechanisms (e.g., keyboards, mice, voice, touchscreens, bioelectric devices, magnetic readers, RFID readers, barcode readers, motion-sensing input devices, etc.) serving as one or more user interfaces for the controller. For example, the one or more controllers may include a graphics subsystem to drive the output mechanism. The links of the peripherals to the system may be wired connections or use wireless communications.

Although summarized above as a PC-type implementation, those skilled in the art will recognize that the one or more controllers also encompasses systems such as host computers, servers, workstations, network terminals, and the like. Further one or more controllers may be embodied in a device, such as a mobile electronic device, like a smartphone or tablet computer. In fact, the use of the term controller is intended to represent a broad category of components that are well known in the art.

Hence aspects of the systems and methods provided herein encompass hardware and software for controlling the relevant functions. Software may take the form of code or executable instructions for causing a controller or other programmable equipment to perform the relevant steps, where the code or instructions are carried by or otherwise embodied in a medium readable by the controller or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile/non-transitory storage media include, for example, optical or magnetic disks, such as any of the storage devices in any computer(s) shown in the drawings. Volatile storage media include dynamic memory, such as the memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a controller can read programming code and/or data. Many of these forms of computer readable media may be involved in carrying one or more sequences of one or more instructions to a processor for execution.

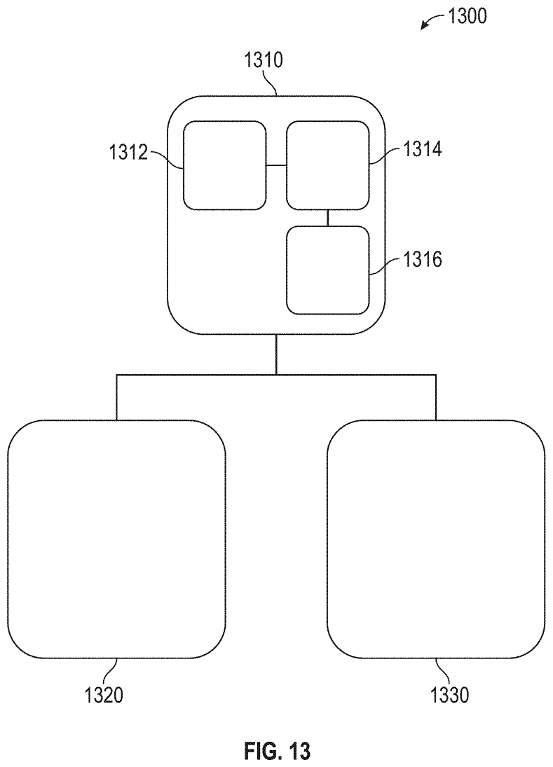

Referring now to FIG. 13, a system 1300 according to an embodiment of the invention is presented. The system 1300 may comprise a server 1310. The server 1310 may be configured to operate a website having the purchase order interface described above. The server may comprise a non-transitory storage medium 1312 comprising software thereon that may be executed to operate the website. The server 1310 may further comprise a controller 1314. The controller 1314 may be operable to execute the software stored on the non-transitory storage medium 1312 to operate the website. The server 1310 may further comprise a network communication device 1316 operable to communicate across a network, such as personal areas networks, local area networks, or wide area networks, such as the internet, either wired or wirelessly. The network communication device 1316 may be any computer hardware operable to communicate across a network as described, including, but not limited to, an Ethernet card, a Wi-Fi card, a Bluetooth card, a mobile network card, and the like, and may be configured to adhere to any IEEE communication protocol, such as 802.xx protocols, and/or mobile network protocol, such as 3G, Long-Term Evolution (LTE), 4G, 5G, and the like as is known in the art.

The system 1300 may further comprise a digital printing device 1320. The digital printing device 1320 may be positioned in communication with the server 1310, either by direct communication or across a network. In some embodiments, the server 1310 may control the operation of the digital printing device 1320. In other embodiments, a separate computerized device may be positioned in communication with each of the server 1310 and the digital printing device 1320, may receive printing instructions from the server 1310, and may control the operation of the digital printing device 1320 responsive to the received instructions. The digital printing device 1320 may be any type of printing device as described hereinabove. In some embodiments, the digital printing device 1320 may be operable to automatically feed printing medium, the base material described above, to print the digital images onto the base material. Types of base material include, but are not limited to, cardboard, liner for cardboard, cardstock, and any other material commonly used in packaging materials.

The system 1300 may further comprise a cutting machine 1330. The cutting machine 1330 may be positioned in communication with the server 1310, either by direct communication or across a network. In some embodiments, the server 1310 may control the operation of the cutting machine 1330. In other embodiments, a separate computerized device may be positioned in communication with each of the server 1310 and the cutting machine 1330, may receive printing instructions from the server 1310, and may control the operation of the cutting machine 1330 responsive to the received instructions. In some embodiments, the base material printed upon by the digital printing machine 1320 may be fed automatically from the digital printing machine 1320 to the cutting machine 1330 without the need for human assistance or intervention. In some embodiments, base material printed upon by the digital printing machine 1320 may require human assistance or intervention to be moved to the cutting machine 1330.

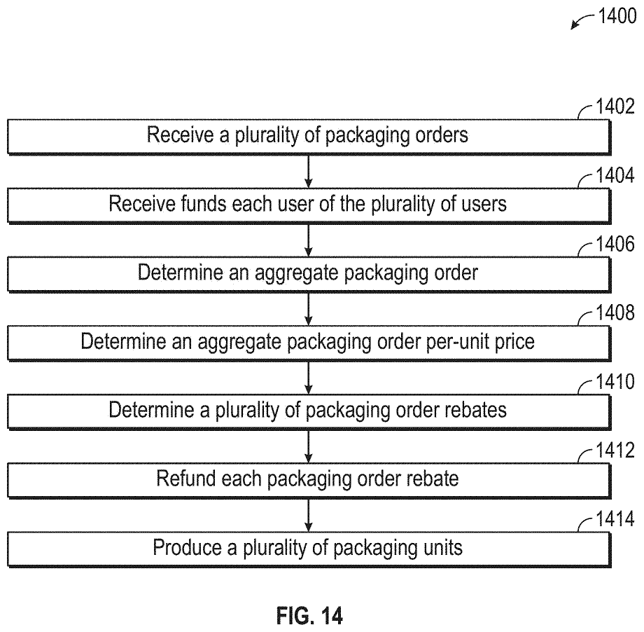

Referring now to FIG. 14, a method 1400 according to an embodiment of the invention is presented. The method 1400 may comprise receiving a plurality of packaging orders each comprising a packaging order parameter set from a plurality of users at a purchase order interface, each packaging order parameter set of the plurality of orders comprising a packaging order dimensioning parameter, a packaging order volume parameter, and a packaging order total price at step 1402. The method 1400 may continue at step 1404 with receiving funds each user of the plurality of users equal to the packaging order total price for their respective packaging orders.

The method 1400 may continue at step 1406 with determining an aggregate packaging order comprising an aggregate packaging order parameter set responsive to the packaging order parameter sets of the plurality of packaging orders, the aggregate packaging order parameter set comprising an aggregate packaging order dimensioning parameter equal to the packaging order dimensioning parameters of the plurality of packaging orders and an aggregate packaging order volume parameter that is at least the sum of the packaging order volume parameters of the plurality of packaging orders. At step 1408 the method 1400 continues with determining an aggregate packaging order per-unit price responsive to the aggregate packaging order parameter set

The method 1400 continues at step 1410 with determining a plurality of packaging order rebates, each packaging order rebate being associated with an order of the plurality of packaging orders, being the difference of the packaging order total price for each packaging order of the plurality of packaging orders and the product of the aggregate packaging order per-unit price and the packaging order volume parameter for each packaging order. Each packaging order rebate may be refunded to the user associated with the packaging order associated with the packaging order rebate at step 1412. The method 1400 may conclude at step 1414 with producing a plurality of packaging units having dimensioning equal to the aggregate packaging order dimensioning parameter and equal in number to the aggregate packaging order volume parameter. The plurality of packaging units may comprise a subset of packaging units assigned to each packaging order of the plurality of packaging orders.

It should be noted that various changes and modifications to the embodiments described herein will be apparent to those skilled in the art. Such changes and modifications may be made without departing from the spirit and scope of the present invention and without diminishing its attendant advantages. For example, various embodiments of the systems and methods may be provided based on various combinations of the features and functions from the subject matter provided herein.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

What is claimed is:

1. A method for aggregating multiple independent packaging orders comprising:
receiving a first packaging order comprising a first packaging order parameter set from a first user at a purchase order interface, the first packaging order parameter set comprising a first packaging order dimensioning parameter, a first packaging order volume parameter, and a first packaging order total price;
receiving funds from the first user equal to the first packaging order total price;
receiving a second packaging order comprising a second packaging order parameter set from a second user at the purchase order interface, the second packaging order parameter set comprising a second packaging order dimensioning parameter, a second packaging order volume parameter, and a second packaging order total price;
receiving funds from the second user equal to the second packaging order total price;
determining an aggregate packaging order comprising an aggregate packaging order parameter set responsive to the first packaging order parameter set and the second packaging order parameter set, the aggregate packaging order parameter set comprising an aggregate packaging order dimensioning parameter equal to the first and second packaging order dimensioning parameters and an aggregate packaging order volume parameter that is at least the sum of the first packaging order volume parameter and the second packaging order volume parameter;
determining an aggregate packaging order per-unit price responsive to the aggregate packaging order parameter set;
determining a first packaging order rebate being the difference of the first packaging order total price and the product of the aggregate packaging order per-unit price and the first packaging order volume parameter;
refunding the first packaging order rebate to the first user;
determining a second packaging order rebate being the difference of the second packaging order total price and the product of the aggregate packaging order per-unit price and the second packaging order volume parameter;
refunding the second packaging order rebate to the second user; and
producing a plurality of packaging units having dimensioning equal to the aggregate packaging order dimensioning parameter and equal in number to the aggregate packaging order volume parameter, wherein the plurality of packaging units comprises a first subset of packaging units assigned to the first packaging order and a second subset of packaging units assigned to the second packaging order.

2. The method of claim 1 wherein:
the first packaging order further comprises a first digital image file defining a first digital image;
the second packaging order further comprises a second digital image file defining a second digital image; and
producing the plurality of packaging units comprises producing the first subset of packaging units having the first digital image printed thereon and producing the second subset of packaging units having the second digital image printed thereon.

3. The method of claim 2 wherein producing the plurality of packaging units comprises:
operating a digital printing device to print the first digital image on a base material a number of times equal to the first packaging order volume parameter and on areas of the base material to be cut into the first subset of packaging units prior to the base material being cut;
operating the digital printing device to print the second digital image on the base material a number of times equal to the second packaging order volume parameter and on areas of the base material to be cut into the second subset of packaging units prior to the base material being cut; and
operating a cutting machine to cut packaging units from the base material in dimensions matching the aggregate packaging order dimensioning parameter, cutting a number of packaging units equal to the aggregate packaging order volume parameter.

4. The method of claim 3 wherein the cutting machine is one of a die cutting machine, a computer-aided design (CAD) cutting machine, and a laser cutting machine.

5. The method of claim 1 further comprising defining an aggregation time period during which received orders will be aggregated; wherein each of the first packaging order and second packaging order are received within the aggregation time period; and wherein packaging orders received outside the aggregation time period will be aggregated into a second aggregated order.

6. The method of claim 1 wherein:
the first packaging order parameter set further comprises an aggregation per-unit price threshold level parameter; and
packaging units for the first packaging order are not produced until the aggregate packaging order per-unit price is equal to or below the aggregation per-unit price threshold level parameter.

7. The method of claim 1 wherein:
the aggregate order parameter set further comprises a minimum order volume;
each of the first packaging order volume parameter and second packaging order volume parameter are compared to the minimum order volume; and
a packaging order comprising an order volume parameter not greater than or equal to the minimum order volume is not included in the aggregate order.

8. The method of claim 1 wherein the aggregate packaging order per-unit price is determined further responsive to at least one of historical aggregated orders prices, historical purchase order prices for one of the first user and the second user, and competitor order prices.

9. The method of claim 1 wherein the aggregate packaging order per-unit price is determined further responsive to a gross margin above a known aggregate cost for producing a quantity of packaging units equal to the aggregate packaging order volume parameter in a size equal to the aggregate packaging order dimensioning parameter.

10. A system for aggregating multiple independent packaging orders comprising:
a server comprising a non-transitory a computer-readable medium comprising software for operating a website configured to:
receive a first packaging order comprising a first packaging order parameter set from a first user at a purchase order interface, the first packaging order parameter set comprising a first packaging order dimensioning parameter, a first packaging order volume parameter, a first packaging order total price, and a first digital image file defining a first digital image;
receive funds from the first user equal to the first packaging order total price;
receive a second packaging order comprising a second packaging order parameter set from a second user at the purchase order interface, the second packaging order parameter set comprising a second packaging order dimensioning parameter equal to the first packaging order dimensioning parameter, a second packaging order volume parameter, a second packaging order total price, and a second digital image file defining a second digital image; and
receive funds from the second user equal to the second packaging order total price;
determine an aggregate packaging order comprising an aggregate packaging order parameter set responsive to the first packaging order parameter set and the second packaging order parameter set, the aggregate packaging order parameter set comprising an aggregate packaging order dimensioning parameter equal to the first and second packaging order dimensioning parameters and an aggregate packaging order volume parameter that is equal to the sum of the first packaging order volume parameter and the second packaging order volume parameter;
determine an aggregate packaging order per-unit price responsive to the aggregate packaging order parameter set;
determine a first packaging order rebate being the difference of the first packaging order total price and the product of the aggregate packaging order per-unit price and the first packaging order volume parameter; and
determine a second packaging order rebate being the difference of the second packaging order total price and the product of the aggregate packaging order per-unit price and the second packaging order volume parameter;
wherein the website is further configured to:
refund the first packaging order rebate to the first user; and
refund the second packaging order rebate to the second user; and
a digital printing device positioned in communication with the server and configured to:
print the first digital image on a base material a number of times equal to the first packaging order volume parameter and on areas of the base material to be cut into a first subset of packaging units assigned to the first packaging order; and
print the second digital image on the base material a number of times equal to the second packaging order volume parameter and on areas of the base material to be cut into a second subset of packaging units assigned to the second packaging order; and
a cutting machine positioned in communication with the server and configured to:
cut the first subset of packaging units from the base material in dimensions matching the aggregate packaging order dimensioning parameter in the areas of base material having the first digital image printed thereupon; and
cut the second subset of packaging units from the base material in dimensions matching the aggregate packaging order dimensioning parameter in the areas of base material having the second digital image printed thereupon.

11. The system of claim 10 wherein the cutting machine is one of a die cutting machine, a computer-aided design (CAD) cutting machine, and a laser cutting machine.

12. The system of claim 10 wherein:
the software for operating a website is further configured to define an aggregation time period during which received orders having the same dimensioning will be aggregated; and
each of the first packaging order and second packaging order are received within the aggregation time period; and wherein orders received outside the aggregation time period will be aggregated into a second aggregated order.

13. The system of claim 10 wherein:
the first packaging order parameter set further comprises an aggregation per-unit price threshold level parameter; and
packaging units for the first packaging order are not produced until the aggregate packaging order per-unit price is equal to or below the aggregation per-unit price threshold level parameter.

14. The system of claim 10 wherein:
the aggregate order parameter set further comprises a minimum order volume;
each of the first packaging order volume parameter and second packaging order volume parameter are compared to the minimum volume order; and
an order comprising an order volume parameter not greater than or equal to the minimum order volume are not included in the aggregate order.

15. The system of claim 10 wherein the software is further configured to determine the aggregate packaging order per-unit price responsive to at least one of historical aggregated orders prices, historical purchase order prices for one of the first user and the second user, and competitor order prices.

16. The system of claim 10 wherein the software is further configured to determine the aggregate packaging order per-unit price responsive to a gross margin above a known aggregate cost for producing a quantity of packaging units equal to the aggregate packaging order volume parameter in a size equal to the aggregate packaging order dimensioning parameter.

17. A method for aggregating multiple independent packaging orders comprising:
receiving a plurality of packaging orders each comprising a packaging order parameter set from a plurality of users at a purchase order interface, each packaging order parameter set of the plurality of orders comprising a packaging order dimensioning parameter, a packaging order volume parameter, and a packaging order total price;
receiving funds from each user of the plurality of users equal to the packaging order total price for their respective packaging orders;
determining an aggregate packaging order comprising an aggregate packaging order parameter set responsive to the packaging order parameter sets of the plurality of packaging orders, the aggregate packaging order parameter set comprising an aggregate packaging order dimensioning parameter equal to the packaging order dimensioning parameters of the plurality of packaging orders and an aggregate packaging order volume parameter that is at least the sum of the packaging order volume parameters of the plurality of packaging orders;
determining an aggregate packaging order per-unit price responsive to the aggregate packaging order parameter set;
determining a plurality of packaging order rebates, each packaging order rebate being associated with an order of the plurality of packaging orders, being the difference of the packaging order total price for each packaging order of the plurality of packaging orders and the product of the aggregate packaging order per-unit price and the packaging order volume parameter for each packaging order;
refunding each packaging order rebate to the user associated with the packaging order associated with the packaging order rebate; and
producing a plurality of packaging units having dimensioning equal to the aggregate packaging order dimensioning parameter and equal in number to the aggregate packaging order volume parameter, wherein the plurality of packaging units comprises a subset of packaging units assigned to each packaging order of the plurality of packaging orders.

18. The method of claim 17 wherein:
the packaging orders of the plurality of packaging orders further comprise digital image files comprising respective digital images; and
producing the plurality of packaging units comprises:
operating a digital printing device to print the digital images on a base material a number of times equal to the packaging order volume parameter for the packaging order associated with each digital image and on areas of the base material to be cut into a subset of packaging units prior to the base material being cut; and
operating a cutting machine to cut packaging units from the base material in dimensions matching the aggregate packaging order dimensioning parameter, cutting a number of packaging units equal to the aggregate packaging order volume parameter.

19. The method of claim 18 wherein the cutting machine is one of a die cutting machine, a computer-aided design (CAD) cutting machine, and a laser cutting machine.

20. The method of claim 17 wherein:
at least one of the packaging order parameter sets of the plurality of packaging order parameter sets further comprises an aggregation per-unit price threshold level parameter; and
packaging units are not produced until the aggregate packaging order per-unit price is equal to or below the aggregation per-unit price threshold level parameter.
